(19) United States
(12) Patent Application Publication
(10) Pub. No.: US 2011/0132266 A1
(43) Pub. Date: Jun. 9, 2011

(54) PET ACTIVATED FEEDER SYSTEM

(76) Inventor: Pierre-Alban Hery, Bushell Park (CA)

(21) Appl. No.: 12/861,864

(22) Filed: Aug. 24, 2010

Related U.S. Application Data
(60) Provisional application No. 61/266,743, filed on Dec. 4, 2009.

(51) Int. Cl. A01K 5/00

(52) U.S. Cl. 119/51.01

(57) ABSTRACT

A feeder includes a vertical housing enclosing a feed reservoir. The upper portion of the feed reservoir is secured by a hinged horizontal extension of the vertical housing. The hinged portion of the vertical housing contains a lid through which the feed reservoir may be replenished. The feed reservoir narrows at its lower end to form a funnel. A shaft with helical screw extends through the feed reservoir, secured to the hinged portion of the housing at its upper end and is restrained by the funnel outlet of the reservoir at its lower end. The shaft protrudes through the outlet of the reservoir where the horizontal lever is affixed to the protruding end of the shaft. The animal dispenses feed through the back-and-forth motion of this lever. A chute is secured to the lower portion of the housing to direct dispensed feed into the animal's feed bowl.

This application claims benefit under 35 U.S.C. 119(e) of U.S. Provisional Patent Application Ser. No. 61/266,743, filed Dec. 4, 2009.

### FIELD OF THE INVENTION

This invention relates to a pet-activated feeder for domestic animals to dispense dry particulate food.

### BACKGROUND OF THE INVENTION

The pet feeder systems to date can be broken down into three major categories: Automatic programmable (Electric) systems, solely mechanical systems, and gravity fed systems.

Automatic programmable feeders rely on electricity to operate and may fail in case of a power failure. Some have battery backup systems but the complexity of these systems make them expensive to acquire. The many parts of electric systems make them hard to clean many complex surfaces are hidden from the user and can harbour bacteria over time. Complete dissasembly of such systems is not reconmended as it will void to warranty of the product.

Solely mechanical systems have been used in an outdoor environment to keep other animals from scavenging the intended pet's food. These systems use a hinged platform to expose the food using the pet's weight. Other mechanical systems used wind up clocks and release mechanisms to release a spring loaded lid.

Gravity fed systems are of the simplest design and maintain a full level of food until the reservoir is empty.

The main detractor of these prior systems is that they do not address the bad habits of the pets themselves. It is very common for pets to eat too fast which hinders proper digestion. No matter what the system a full meal portion is available to the pet which fails to regulate their eating habits. Other simpler systems use a simple ball in the pet's bowl to hinder the pet and slow its down but most pets easily defeat this system by removing the foreign object from the bowl and continuing with their meal. Lack of stimulation in a pet is one of the biggest drivers for bad behaviour; all systems described above will unconditionally provide the pet with food, and accordingly do not stimulate the animal. The pet then learns that food will always be there without having to do anything for it.

### SUMMARY OF THE INVENTION

According to a first aspect of the invention there is provided an animal activated feeder system comprising:

a feed reservoir defined by an interior of a container having a feed opening communicating an exterior of the container with the feed reservoir at one end of the container;

a frame arranged to support the container in an upright position with the feed reservoir positioned over the feed opening;

a dispensing member pivotal about a longitudinal axis thereof and arranged to extend through the feed opening in a position disposed partially within the feed reservoir with a bottom end of the dispensing member disposed outside the container below the feed opening, the dispensing member defining a passage lying on a helical path about the longitudinal axis to extend at least partially along a length of the dispensing member over at least a partial portion of said length that passes through the feed opening; and

a lever projecting outward from the dispensing member between the bottom end thereof and the partial portion of the length thereof that passes through the feed opening to position a distal end of the lever at a distance radially outward from the longitudinal axis of the dispensing member.

Preferably the dispensing member comprises a shaft and the passage comprises a recess in an outer periphery of the shaft.

Preferably the recess in the outer periphery of the shaft is defined by a helical groove formed therein on the helical path about the longitudinal axis.

Preferably the container has a fill opening in an end thereof opposite the feed opening.

Preferably there is provided an openable and closeable cover operable to selectively cover and at least partially uncover the fill opening.

Preferably the frame is an upright stand arranged to sit atop a floor or ground surface and support the container at a height thereabove.

Preferably the frame comprises a base and an upright structure projecting upward from the base to support the container thereabove, the base presenting two feet projecting to one side of the upright structure on opposite sides of the feed opening to accommodate a bowl between the feet to receive feed from the feed opening in operation of the feeder.

Preferably the feet of the base are separated by an arcuate cutaway extending into the base from a side thereof opposite the upright structure.

Preferably there is provided a feed guide supported on the frame at a position below the dispensing member and the feed opening of the container to direct feed therefrom to a location not directly beneath the feed opening.

Preferably the feed guide is adjustable to change the location to which the feed is directed.

Preferably the feed guide comprises a ramp pivotally mounted on the frame to allow pivoting of a free end of the ramp upward and downward toward and away from the feed opening above.

Preferably the container is removable from the frame.

Preferably the dispensing member is removable from the container.

Preferably the dispensing member is pivotally suspended from a connection at a top end thereof proximate a top end of the container.

Preferably the dispensing member is pivotally suspended from a connection at a top end thereof with the cover proximate a top end of the container.

Preferably connection at the top end of the dispensing member is a quick release connection.

Preferably the dispensing member is slidable through the feed opening into the connection with the cover.

Preferably the container comprises a tapered portion narrowing toward the feed opening.

Preferably the container comprises a neck of lesser diameter than a remainder of the container and at which the feed opening is defined, the frame comprising a laterally projecting support having a hole therein for receiving the neck to support the end of the container at which the feed opening is defined.

Preferably the frame comprises a lower support engaging the container at a distance below the cover, the cover being pivotal into and out of a closed position over the fill opening of the container to close and open the fill opening and to support the end of the container opposite the feed opening when closed.

Preferably a side of the cover facing downward when closed is grooved to receive the end of the container opposite the feed opening in this grooved side to secure the container in place between the lower support and the cover.

Preferably the end of the container opposite the feed opening is recessed toward the end at which the feed opening is defined at one or more positions about a circumference of the container, and one or more breaks along a circular path on which the cover is otherwise grooved each cooperate with a respective recess in the end of the container to block rotation of the container.

### BRIEF DESCRIPTION OF THE DRAWINGS

In the accompanying drawings, which illustrate an exemplary embodiment of the present invention:

FIG. 1 is an isometric view of a pet activated feeder according to the present invention.

FIG. 2 is a partially exploded isometric view of the base, frame and lower support of the feeder from above.

FIG. 3 is a partially exploded isometric view of the base, frame and lower support from below.

FIG. 4 is a partially exploded isometric view of the base, frame, lower support and feed reservoir of the feeder.

FIG. 5 is a partially exploded isometric view of the top cover, frame, and feed reservoir of the feeder.

FIG. 6 is a partial isometric view of the pet activated feeder with a fill level label applied thereto.

FIG. 7 is a partially exploded isometric view of the top cover hinge of the feeder.

FIG. 8 is a partially exploded isometric view of the locking pins for the top cover of the feeder.

FIG. 9 shows exploded and assembled isometric views of the lid assembly of the feeder.

FIG. 10 is a partially exploded isometric view of the top cover with the lid assembly removed.

FIG. 11 is a partial isometric view of the lid assembly installed in the top cover.

FIG. 12 is an isometric view of the pet activated feeder showing the keychain-type quick release fastening mechanism used to pivotally hang a helically grooved dispensing shaft of the feeder.

FIG. 13 is a partial cross-sectional view of the feeder illustrating the keychain-type fastening mechanism of the hanging support in greater detail.

FIG. 14 a partial cross-sectional view of the dispensing shaft and its fastening mechanism component after removal of the shaft from the rest of the feeder.

FIG. 15 an isometric view of the ramp and feed bowl coupling in use of the feeder.

FIG. 16 is a partially exploded isometric view of the ramp and its hinge.

### DETAILED DESCRIPTION

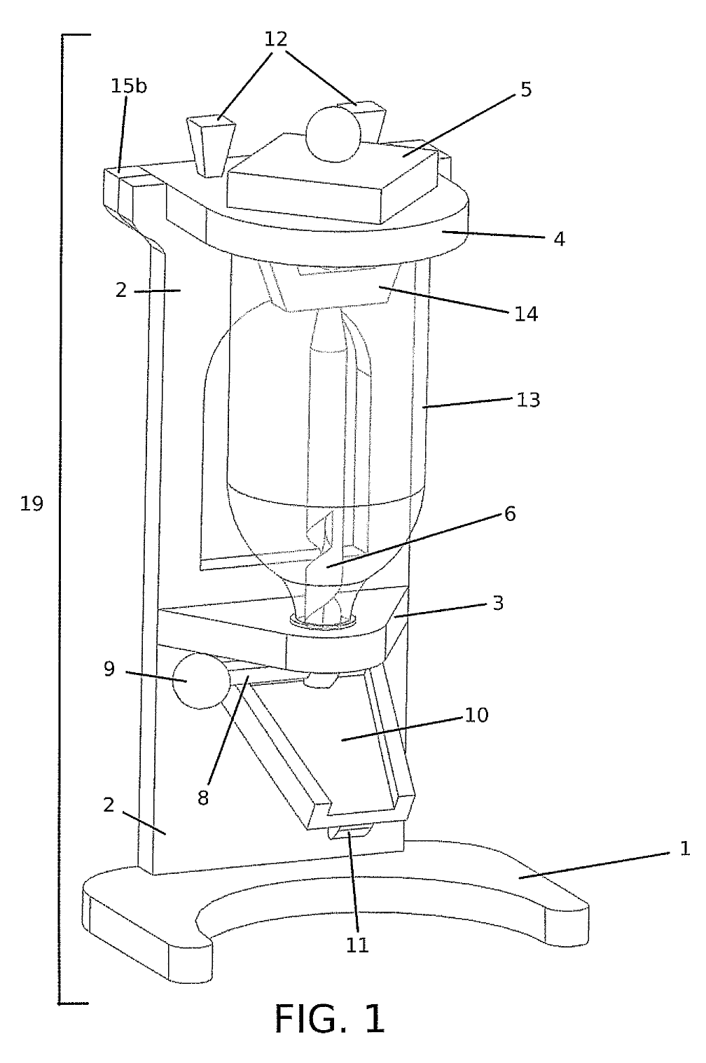

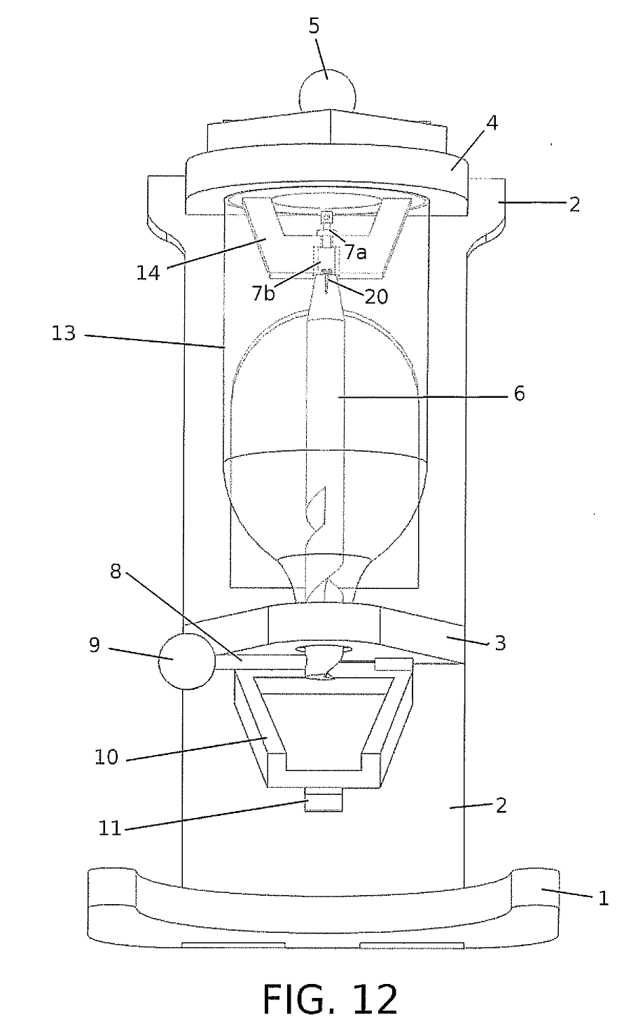

FIG. 1 best depicts an embodiment of the present invention based on a prototype pet activated feeder 19 made of all wooden parts for the exception of the feed reservoir 13, the valet keychain quick-release mechanism 7b and 7c and its screw 20 shown in FIG. 12. The feed reservoir 13 is defined by a recycled clear plastic two litre plastic beverage container with the bottom removed and mounted in an inverted orientation between lower support 3 and top cover 4 as shown in FIG. 1.

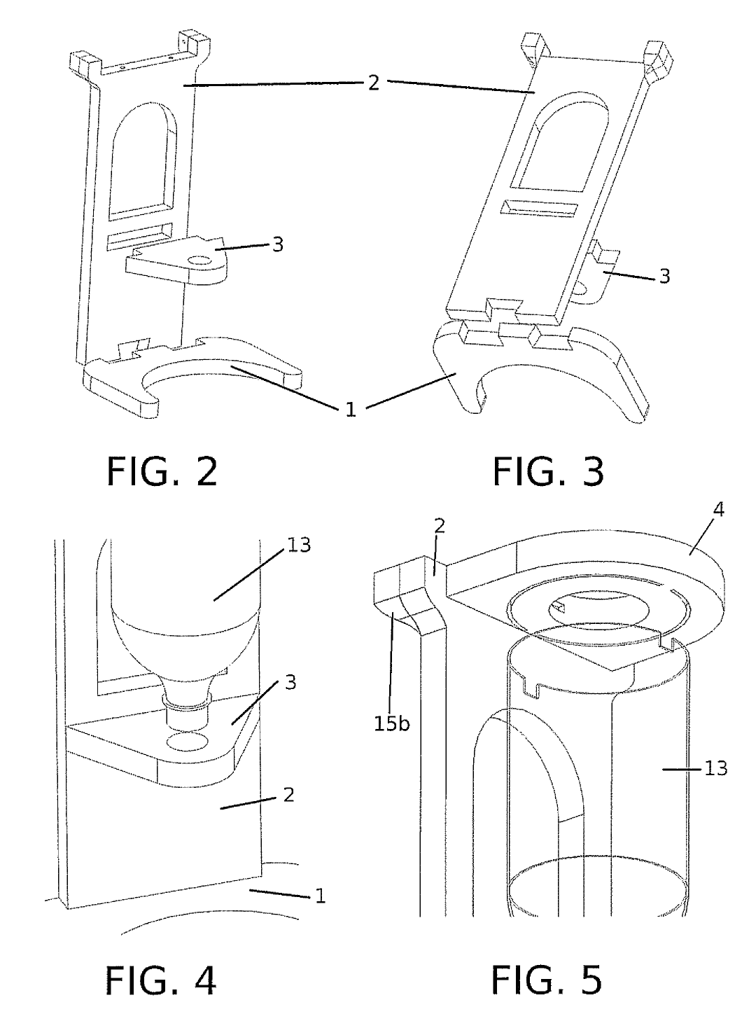

Referring to FIGS. 2 and 3, a horizontal base 1 presenting a planar bottom surface for seating the frame atop a ground or floor surface includes a semicircular cut out leaving an arcuate recess extending into the base from one side thereof to allow for the placement of a feed bowl between the resulting feet left on opposite sides of the cut-out. The base 1 is connected via dovetail joint and wood glue to the frame 2 projecting vertically upward from the base. The lower support 3 is joined to the vertical housing 2 via mortise and tenon joint secured with wood glue to project horizontally outward to the same side of the frame or housing as the base.

Referring to FIGS. 4 and 5, the neck of the container defining a smaller diameter dispensing end of the feed reservoir 13 slides into the circular cut out defining a vertical through hole in the lower support 3. The feed reservoir 13 is fixed at its uppermost end by pair of nearly semicircular arcuate grooves in the under side of top cover 4. The uppermost edge of the feed reservoir 13 is notched front and back at diametrically opposite positions about the circumference of the container to fit into top cover 4 and to prevent the rotation of the feed reservoir 13 within the support assembly 3,4. That is, the two remaining un-notched portions of the container's top end separated by the two notches fit respectively into the two arcuate grooves in the under side of the top cover. The two arcuate grooves lie on a common circular path on the cover, but are separated by un-grooved or un-recessed breaks between the grooves on this circular path where the originally flat underside surface of the cover is left intact. These two intact portions between the grooves fit into the notches in the end of the container so that when the cover is fitted over the end of the container, the ungrooved intact portions of the cover on the circular path (i.e. the breaks between the grooves) block rotation of the container by contact with the ends of the two remaining arcuate portions of the container's circumference at the top end thereof. It will be appreciated that the number of notches and corresponding number of breaks in the grooving of the cover's underside along a circular path may be varied while still accomplishing this fixing of the container's position. For example, as little as one arcuate groove with a single break defining its opposite ends may cooperate with a single notch (or one of a plurality of notches) to achieve the same rotation-blocking effect on the container.

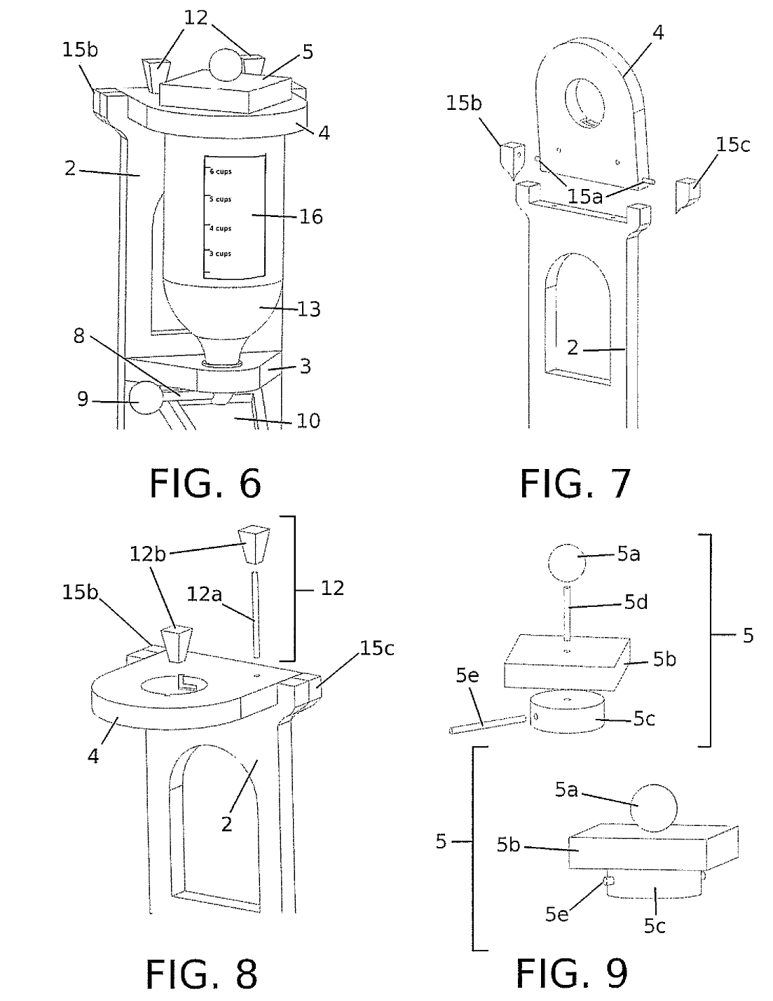

FIG. 6 shows the label 16 affixed to the front side of the feed reservoir 13, which indicates the fill level of the feed reservoir 13.

Referring to FIG. 7, the top cover 4 is attached to the top of the frame 2 via dowel 15a. Dowel 15a slides into the horizontal hole in top cover 4 and mates with holes in both hinge supports 15b and 15c. Hinge supports 15b and 15c are fastened to the rear of frame 2 with wood glue to form a hinge with the dowel. This hinge allows the top cover 4 to be rotated upward off the top of the container such that feed reservoir 13 may be removed from its installed position clamped between the lower support and the cover 4 for cleaning.

FIG. 8 shows top cover 4 in its lowered or closed position fitting over the top end of the reservoir container. Top cover 4 is locked in place with pins 12. Each pin 12 is a dowel 12a fitted with a knob 12b. The dowels of the pins 12 are inserted in matched holes in top cover 4 and the upper edge surface of the frame 2. When in place, the flat lowermost face of the knob 12b lies flush with the upper surface of top cover 4 and prevents the top cover 4 from being rotated out of the horizontal closed position securing the bottle in place against the lower support.

Referring to FIG. 9, the lid assembly 5 is comprised of five pieces, specifically a knob or handle 5a, a top square block 5b, a bottom cylindrical block 5c, a dowel 5d and a locking pin 5e. Dowel 5d connects the knob 5a, the top square block 5b and the bottom cylindrical block 5c through their centres. Locking pin 5e fits horizontally through the centre of cylinder 5c and protrudes evenly on both sides. The lid assembly components 5 a-e are secured together with wood glue.

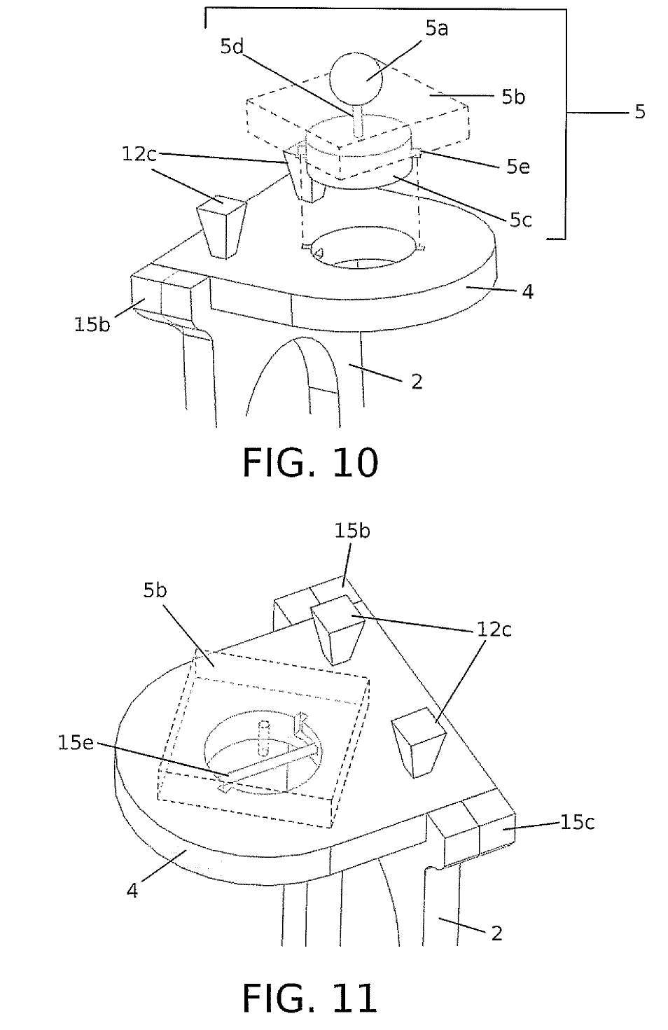

Referring to FIG. 10 and FIG. 11, the cylindrical body 5c of the lid assembly 5 fits into the circular cut out forming a vertical through-hole in the top cover 4. Ends of the locking pin 5e passing diametrically through the cylindrical body fit into the vertical legs of L-shaped grooves inside the circular cut out in the top cover 4, which allows the cylindrical body of the lid assembly 5 to be lowered into the top cover 4 by passing the locking pin of the lid assembly into and downwardly along the vertical leg of each L-shaped groove extending into the top cover from the top face thereof at the periphery of the cylindrical through hole therein to open into the through hole. After the locking pin has reached the bottom of the groove's vertical portion, the lid assembly 5 is then rotated clockwise which locks it to top cover 4 using the knob handle 5a fixed atop the lid assembly's vertical dowel 5d to slide the locking pin ends along the horizontal legs of the L-shaped grooves to ends of the horizontal groove portions opposite the vertical groove portions from which they extend. When the lid assembly 5 is in place in this closed position, the bottom of a top block 5b fixed atop the cylindrical body 5c will be flush with the top face of the top cover 4. The top block provides a visual marker with the positions of the rectangular block's corners indicating to a user whether the lid assembly is in the locked condition, and also ensures that the feed reservoir isn't partially exposed to the outside environment by covering any gap between the cylindrical part and the opening in the cover, as the fit between these parts is not be 100% sealed. The top block also aids in keeping the axes of the cylindrical part and the cover opening aligned so that the lid assembly sits horizontally in the closed position. In addition, the top block may also serve an aesthetic purpose providing an appealing appearance. The knob and top block can be combined into a single functional unit. It will be appreciated that the term clockwise is used here in terms of the illustrated embodiment, and that the opposite rotational direction (counterclockwise) would apply for an alternate embodiment in which the horizontal portions of the L-shaped grooves extend in the opposite direction.

Referring to FIG. 12, the shaft 6 is made of a wooden dowel of a diameter which enables it to fit through the lower feed opening of the feed reservoir 13 defined by the free end of the container neck furthest from the rest of the container. The lower portion of the shaft 6 is cut to form a helical groove recessing into the otherwise cylindrical periphery surface of the shaft such that the depth of the resulting screw allows dry particulate food to fit within the diameter of the shaft 6. The recessed depth of the helical groove need not necessarily accommodate the full size of the particulate feed therein, so long as the food particles will fit in the space defined by the combination of the groove depth with the radial distance between the shaft's outer diameter and the surrounding neck wall of the container defining the boundary of the feed opening. This radial spacing between the outer diameter of the shaft and the boundary of the feed opening is alone less than the food particle size to prevent feed from simply free falling from the reservoir between the shaft the container's neck wall at the feed opening. The length of shaft 6 is such that is protrudes from the dispensing end of the feed reservoir 13 to present a bottom end of the shaft outside the container at a position below the feed opening therein. The helical screw on the lower portion of the shaft stretches from this bottom end of the shaft upward into the feed reservoir inside the container, past the container's neck to nearly reach the opposite end of the tapered portion of the container that connects the smaller diameter neck to the larger diameter remainder of the container above. A horizontal lever 8 is attached to the portion of shaft 6 that protrudes from the feed reservoir 13. A spherical member 9 is fastened to the distal end of the horizontal lever 8 furthest from the shaft. Hanging support 14 is fastened to the underside of top cover 4 with wood glue. Two converging end legs of the hanging support depend downwardly from the top cover from opposite sides of the through-hole therein and have their closer-together bottom ends interconnected by a central span of the hanging support.

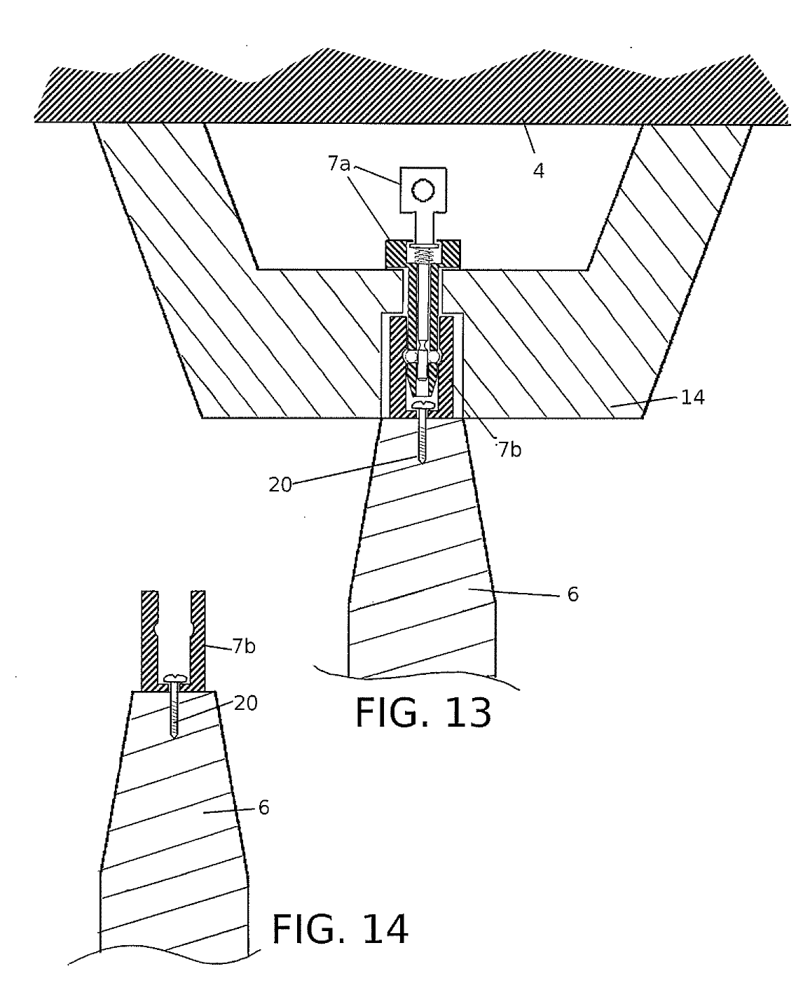

Referring to FIGS. 13 and 14, a valet keychain mechanism 7a and 7b fastens the shaft 6 to the central span of the hanging support 14 while allowing relative rotation between the two about the shaft's axis. The plunger equipped fastener component 7a of the keychain is slipped into a vertical hole passing through the central span of the hanging support 14. The wider head part of the fastener 7a lays flush with the top of the hanging support 14. The removable sleeve attachment 7b of the keychain mechanism is fastened to the top of the shaft 6 by a screw 20 through the closed end of the sleeve. Removable sleeve attachment 7b fits into a larger recess in the bottom of the central span of the hanging support 14 and lines up with the fastener 7a. Pressing down on the plunger of the fastener 7a enables the sleeve 7b to slide up and cover the lower part of the fastener 7a. Once 7a and 7b are mated the plunger is released and lifted by an internal spring. This action fastens shaft 6 to the hanging support 14 while enabling the shaft 6 to rotate freely about its longitudinal axis. As swiveling quick-release fastening mechanisms of this type are well known and commercially available, additional structural and functional details of the mechanism are not required herein. One prior art example of a clevis pin that operates in a manner similar to the plunger-equipped half of the mechanism illustrated in the drawings appended hereto is presented in U.S. Pat. No. 2,786,383, herein incorporated by reference. The plunger-equipped component of the mechanism illustrated in the drawings appended hereto differs from the prior art clevis pin in that the plunger uses a captured push-button actuator instead of a cam-lever, but valet keychain fasteners typically use such a push button arrangement.

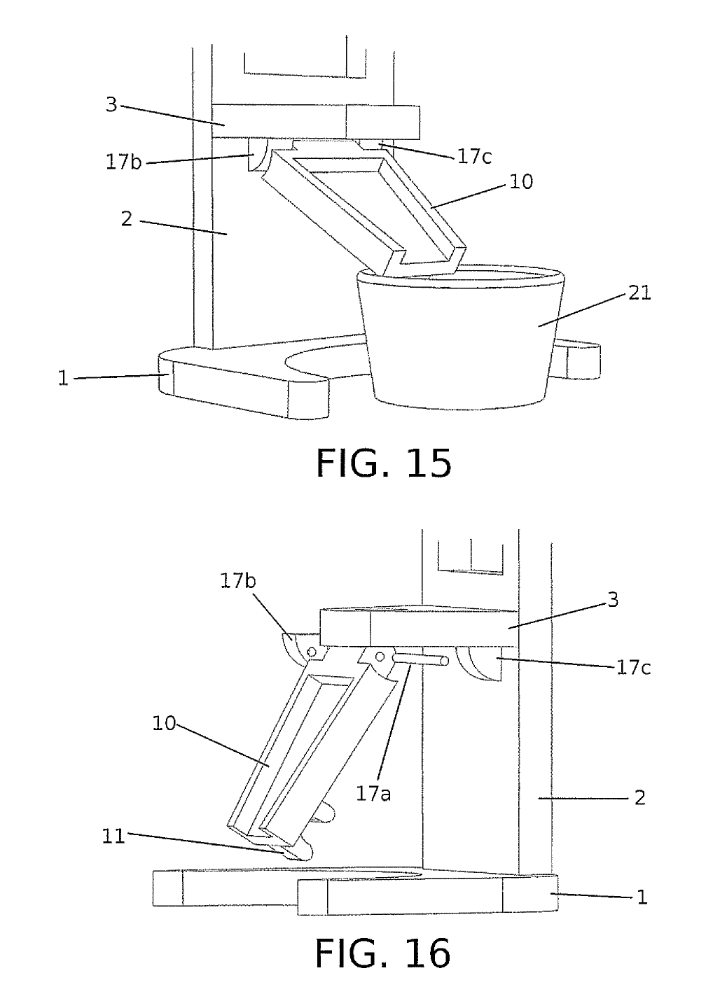

Referring to FIGS. 15 and 16, the ramp 10 is recessed in the centre to form a chute or slide having side walls to guide dry particulate food to the food bowl 21 positioned between the feet of the base. The ramp 10 is attached to the frame 2 and lower support 3 with horizontal dowel 17a passing through it, opposite ends of which fit into coaxial blind holes in support blocks 17 b and 17c fixed proximate opposite sides of the lower support between the front face of the frame and the bottom face of the lower support. The dowel and support block 17a-c form a wooden hinge which enables the angle at which the ramp 10 slopes obliquely downward away from the lower support and frame to be changed to accommodate a variety of feed bowls 21. Feed bowl retainer 11 is fasted to the underside of the ramp 10 with wood glue to present a downward facing channel extending across the ramp adjacent the free end thereof opposite the connection to the frame. The feed bowl retainer 11 couples the ramp 10 and feed bowl 18 to reduce spillage, ensuring the feed dispensed from the reservoir through feed opening at the bottom of the container via the helical groove in the shaft is guided directly into the bowl and to resist or prevent movement of the bowl from such a feed-receiving position by the feeding animal. In use, the illustrated ramp thus extends downwardly away from the frame beneath the feed opening of the container to guide feed to a laterally outward location of the feed bowl not directly beneath the feed opening.

The invention as described above for aesthetic reasons uses common woodworking joints and wood glue to fasten parts together, and the strength of this design has proven more then adequate for small domestic animals like cats and small dogs. For larger animals the joint design can be altered to incorporate stronger joints with screws and/or metal brackets. The specific prototype design described above uses pine board as its main material because it is easy to work with and allowed quick alteration until the design was perfected. Other materials such as plastics or sheet metal can alternatively be employed, and may be more suitable for larger scale production.

Two litre recycled containers were chosen as the feed reservoir for the invention as they are plentiful in supply, made of a clear plastic which makes it easy to check the level of food within the reservoir for the user, and have a smoothly tapered shape funneling or narrowing toward the container opening through which feed is dispensed, thereby minimizing tendency for undispensed food to remain at the bottom of the container. However, it will be appreciated that containers of other sizes, shapes and materials may alternatively be employed. The depth of cut within the helical screw assembly will need to vary for different types of dry foods. An assorted arrangement of screw shafts is needed to function with different size foods. Once the shallowest screw required for a size of food is identified, deeper screws may be used to increases the flow of food.

This prototype on which the illustrated embodiment is based was built around the feed reservoir. This creates two restrictions. The first is that the size of the food cannot exceed the size of the outlet hole. This is easily addressed by scaling the feed reservoir to incorporate a larger outlet hole. The second restriction is that the size of the dispensing screw is limited by the size of the outlet hole. In this design the material used for the dispensing screw is hardwood. When coring out the wood screws there is a critical point at which the strength of the screw is compromised. The maximum recommended depth of cut is equal to the radius of the wooden rod itself. This restriction occurs only because of the strength limitations of wood. Changing the material to plastics or metal would remedy this issue. For example, a plastic or metal dispensing screw could resemble or be in the form of a corkscrew-like structure as opposed to a helically grooved shaft, with spacing between turns of the corkscrew being sufficient to accommodate a food particle and the diameter of the empty cylindrical space about which the corkscrew helically coils being too small to accommodate a fool particle to prevent feed from free falling from the reservoir through the centre of the corkscrew. Like the illustrated helically-grooved shaft, a corkscrew coaxially aligned with the feed opening of the reservoir container would provide a feed passage extending downwardly through the feed opening along the axis on a helical path thereabout, this passage being defined between sequential turns of the corkscrew rather than remaining intact full-diameter portions of a grooved shaft.

It is conceived that the feed passage, although lying on a helical path, need not itself be fully helical. That is, a shaft could have a peripheral groove cut or formed therein that extends along a helical path about the shaft's axis but does not complete a full passage around the circumference thereof (i.e. doesn't complete a full 360° turn around the axis). Accordingly, such a non-vertical sloped peripheral groove having the same pitch angle as the illustrated helical groove would not extend over as long a portion of the shaft's total length, and instead may be just long enough to pass fully through the feed opening from a position sufficiently far up the neck of the container to receive feed therefrom.

Hinges where manufactured out of wood for aesthetic reasons but could easily be change to brass, other metal or plastic hinges. It will also be appreciated that the frame design may be modified, for example to replace the upright, self-supporting stand configuration with a bracket or frame configured to fasten to a wall or other support structure to carry the feed reservoir container at an elevation above the ground, floor or other surface where food is to be dispensed. However, the illustrated embodiment is preferred, as the stand-alone frame or housing can be used at any location, a top filling end of the container can be accessed without having to remove the container from the frame, the container can be removed from the frame for cleaning, and the dispensing shaft can be removed from the container for cleaning or for replacement or substitution by a shaft of different recessed depth at the helical groove in order to change a delivery rate of a given food particle size or adapt the system to another food of different particle size. Even in embodiments retaining the feature of a removable dispensing shaft, it will be appreciated that other swiveling or pivoting fastening arrangements may be used in place of the valet keychain type mechanism to pivotally support the shaft.

### OPERATION OF THE INVENTION

If already in place, rotate the lid 5 counter clockwise to release the lid from the locked condition and lift the lid from its closed position cooperating with the cover to complete the closure of the top filling end of the container. Fill the feed reservoir 13 with as much dry particulate food as required. Replace the lid 5 to its closed position nested partly within the cover and rotate clockwise to lock. Place the feed bowl retainer 11 at the end of the ramp 10 on the edge of the feed bowl 21.

Back and forth motion of the horizontal lever 8 will dispense feed into the feed bowl.

From an assembled state, the following steps are taken to disassemble the feeder. First the lid 5 is rotated counter clockwise and lifted. This action exposes the dispensing screw shaft 6 retaining mechanism 7a. By pressing down plunger-equipped component or actuator portion 7a of the keychain mechanism and pulling simultaneously downward on the dispensing screw 6 from the bottom, the dispensing screw can be removed by the resulting sliding the hollow sleeve half 7b of the fastening mechanism from off the free end of the actuator half 7a. The two retaining pins 12 can each be removed with an upward pulling motion. The top cover 4 can then be rotated upward to release the feed reservoir 13. The reverse process is performed to reassemble.

### Pet Training

Domestic animals are very food driven which makes the teaching process simple. For canine pets, place peanut butter or other similar substance on the lever 8, ensure that the animal witness the food being poured into the feed reservoir 13. The natural reaction of the animal will be to lick the lever 8 and cause the machine to operate. The process is repeated until the animal learns that moving the lever is rewarded with food. For feline pets similar technique as for canines may be used or attaching one of the cat's favourite toys to the lever 8 will have the cat associate operating the lever with food rewards.

### Possible Uses

Fill and set for the animal to dispense as needed.

Place a single meal portion for each meal to simply slow down the pet's rate of consumption.

Use over a period of time where the owner is away. Knowing how much the pet eats on a regular basis and calculating how long it will last. Time to operate unattended is to be determined on a case by case basis.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An animal activated feeder system comprising:
a feed reservoir defined by an interior of a container having a feed opening communicating an exterior of the container with the feed reservoir at one end of the container;
a frame arranged to support the container in an upright position with the feed reservoir positioned over the feed opening;
a dispensing member pivotal about a longitudinal axis thereof and arranged to extend through the feed opening in a position disposed partially within the feed reservoir with a bottom end of the dispensing member disposed outside the container below the feed opening, the dispensing member defining a passage lying on a helical path about the longitudinal axis to extend at least partially along a length of the dispensing member over at least a partial portion of said length that passes through the feed opening; and
a lever projecting outward from the dispensing member between the bottom end thereof and the partial portion of the length thereof that passes through the feed opening to position a distal end of the lever at a distance radially outward from the longitudinal axis of the dispensing member.

2. The animal activated feeder system of claim 1 wherein the dispensing member comprises a shaft and the passage comprises a recess in an outer periphery of the shaft.

3. The animal activated feeder system of claim 2 wherein the recess in the outer periphery of the shaft is defined by a helical groove formed therein on the helical path about the longitudinal axis.

4. The animal activated feeder system of claim 1 wherein the container has a fill opening in an end thereof opposite the feed opening.

5. The animal activated feeder system of claim 4 comprising an openable and closeable cover operable to selectively cover and at least partially uncover the fill opening.

6. The animal activated feeder system of claim 1 wherein the frame is an upright stand arranged to sit atop a floor or ground surface and support the container at a height thereabove.

7. The animal activated feeder system of claim 6 wherein the frame comprises a base and an upright structure projecting upward from the base to support the container thereabove, the base presenting two feet projecting to one side of the upright structure on opposite sides of the feed opening to accommodate a bowl between the feet to receive feed from the feed opening in operation of the feeder.

8. The animal activated feeder system of claim 7 wherein the feet of the base are separated by an arcuate cutaway extending into the base from a side thereof opposite the upright structure.

9. The animal activated feeder system of claim 1 comprising a feed guide supported on the frame at a position below the dispensing member and the feed opening of the container to direct feed therefrom to a location not directly beneath the feed opening.

10. The animal activated feeder system of claim 9 wherein the feed guide is adjustable to change the location to which the feed is directed.

11. The animal activated feeder system of claim 10 wherein the feed guide comprises a ramp pivotally mounted on the frame to allow pivoting of a free end of the ramp upward and downward toward and away from the feed opening above.

12. The animal activated feeder system of claim 1 wherein the dispensing member is removable from the container.

13. The animal activated feeder system of claim 1 wherein the dispensing member is pivotally suspended from a connection at a top end thereof proximate a top end of the container.

14. The animal activated feeder system of claim 13 wherein the connection at the top end of the dispensing member is a quick release connection.

15. The animal activated feeder system of claim 13 wherein the dispensing member is slidable through the feed opening into the connection.

16. The animal activated feeder system of claim 1 wherein the container comprises a tapered portion narrowing toward the feed opening.

17. The animal activated feeder system of claim 1 wherein the container comprises a neck of lesser diameter than a remainder of the container and at which the feed opening is defined, the frame comprising a laterally projecting support having a hole therein for receiving the neck to support the end of the container at which the feed opening is defined.

18. The animal activated feeder system of claim 5 wherein the frame comprises a lower support engaging the container at a distance below the cover, the cover being pivotal into and out of a closed position over the fill opening of the container to close and open the fill opening and to support the end of the container opposite the feed opening when closed.

19. The animal activated feeder system of claim 18 wherein a side of the cover facing downward when closed is grooved to receive the end of the container opposite the feed opening in this grooved side to secure the container in place between the lower support and the cover.

20. The animal activated feeder system of claim 19 wherein the end of the container opposite the feed opening is recessed toward the end at which the feed opening is defined at one or more positions about a circumference of the container, and one or more breaks along a circular path on which the cover is otherwise grooved each cooperate with a respective recess in the end of the container to block rotation of the container.
